(19) United States
(12) Patent Application Publication
(10) Pub. No.: US 2025/0108649 A1
(43) Pub. Date: Apr. 3, 2025

(54) OPENING AND CLOSING DEVICE, IMAGE FORMING APPARATUS INCLUDING OPENING AND CLOSING DEVICE, AND GAS SPRING UNIT FOR IMAGE FORMING APPARATUS

(71) Applicant: CANON KABUSHIKI KAISHA, Tokyo (JP)

(72) Inventor: JUNICHI MOTEKI, Chiba (JP)

(21) Appl. No.: 18/903,846

(22) Filed: Oct. 1, 2024

(30) Foreign Application Priority Data
Oct. 3, 2023 (JP) 2023-172271

(51) Int. Cl. B41J 29/13; B41J 11/00; B41J 13/08; E05F 1/10

(52) U.S. Cl. CPC B41J 29/13; B41J 11/006; B41J 13/08; E05F 1/1091; E05Y 2201/224; E05Y 2201/478

(57) ABSTRACT

An opening and closing device includes a housing having a top surface including an opening portion, a cover configured to open and close the opening portion and provided to the housing to be pivotable about a pivot shaft extending in a first direction, and a gas spring unit configured to extend and contract with the pivoting of the cover and including a cover-side end portion configured to be fitted to the cover and a housing-side end portion configured to be fitted to the housing, wherein the housing further includes a guide portion configured to restrict a movement range of the gas spring unit by bringing a housing-side shaft into contact with the guide portion and guide the housing-side shaft to a position where the housing-side shaft fits to a housing-side fitting portion in inserting the housing-side end portion of the gas spring unit into the housing from the opening portion.

### BACKGROUND

### Field

The present disclosure relates to an opening and closing device for opening and closing a cover provided to a housing, an image forming apparatus including the opening and closing device, and a gas spring unit for the image forming apparatus.

### Description of the Related Art

An electrophotographic or inkjet image forming apparatus that includes a housing having a top surface provided with a cover configured to open and close is discussed. Japanese Patent Application Laid-Open No. 2010-188624 discusses an inkjet recording apparatus configured to form images on sheets with ink. In the inkjet recording apparatus, for example, a conveyance roller for conveying a sheet, an ink drying portion for drying ink on the sheet, and a fixing roller for fixing the ink to the sheet after the drying process are arranged along a conveyance path through which the sheet is conveyed. A housing that encloses the foregoing components is provided with a cover configured to open upward and close, and some of the conveyance roller, the ink drying portion, and the fixing roller are placed on the cover so that the placed components can be lifted together with the cover. An operator can open the cover and conduct jam clearing operations to remove a sheet jammed in the conveyance path and maintenance operations such as cleaning the conveyance roller, the ink drying portion, and the fixing roller.

In a case where some of the conveyance roller, the ink drying portion, and the fixing roller are placed on the cover as described above, the weight of the cover with the components becomes heavier. Thus, an opening and closing device that assists an operator in opening and closing a cover using a gas spring so that the operator can open and close the cover smoothly is discussed (Japanese Patent Application Laid-Open No. 2007-121588). One end portion of the gas spring is pivotably supported by the cover, and another end portion of the gas spring is secured to a housing with screws.

### SUMMARY

According to some embodiments, an opening and closing device may have a housing with a top surface including an opening portion; a cover provided to the housing to be pivotable about a pivot axis extending in a first direction, and configured to open and close the opening portion by pivoting about the pivot axis; and a gas spring unit configured to extend and contract with the pivoting of the cover and including a cover-side end portion fitted to the cover and a housing-side end portion fitted to the housing, wherein the cover-side end portion of the gas spring unit includes a cover-side shaft extending in the first direction, wherein the cover includes a cover-side fitting portion to which the cover-side shaft is fitted, wherein the gas spring unit supports the cover in a state where the gas spring unit is pivotable about the cover-side shaft with respect to the cover, by the cover-side shaft fitting to the cover-side fitting portion, wherein the housing-side end portion of the gas spring unit includes a housing-side shaft extending in the first direction, wherein the housing includes a housing-side fitting portion to which the housing-side shaft is fitted, wherein the housing supports the gas spring unit in a state where the gas spring unit is pivotable about the housing-side shaft with respect to the housing, by the housing-side shaft fitting to the housing-side fitting portion, and wherein the housing further includes a guide portion configured to restrict a movement range of the gas spring unit by coming into contact with the housing-side shaft in inserting of the housing-side end portion of the gas spring unit into the housing from the opening portion and to guide the housing-side shaft to a position where the housing-side shaft fits to the housing-side fitting portion.

An image forming apparatus according to some embodiments may include the opening and closing device described above, and an image forming portion configured to form an image on a medium.

An image forming apparatus according to some embodiments may include the opening and closing device described above, and conveyance device to convey a medium for forming an image, wherein an image forming portion configured to form an image on a medium, wherein the conveyance device includes a first conveyance belt positioned inside the cover and a second conveyance belt positioned inside the housing.

A gas spring unit according to some embodiments may include a first gas spring configured to extend and contract in a first direction, a second gas spring configured to extend and contract in the first direction, a first shaft extending in a second direction intersecting the first direction, and a second shaft extending in the second direction, wherein the first gas spring includes a first through hole at end of the first gas spring on a first side in the first direction and a second through hole at end of the first gas spring on a second side in the first direction, wherein the second gas spring includes a third through hole at end of the second gas spring on the first side and a fourth through hole at end of the second gas spring on the second side, wherein the first shaft is inserted into both the first through hole of the first gas spring and the third through hole of the second gas spring, and wherein the second shaft is inserted into both the second through hole of the first gas spring and the fourth through hole of the second gas spring.

Further features of the present disclosure will become apparent from the following description of exemplary embodiments with reference to the attached drawings.

### BRIEF DESCRIPTION OF THE DRAWINGS

FIG. 1 is a schematic diagram illustrating a suitable inkjet recording apparatus using an opening and closing device according to an exemplary embodiment of the present disclosure.

FIG. 2 is a perspective view illustrating a state where a top cover of a fixing module is opened.

FIG. 3 is a right side view illustrating an opening and closing device according to an exemplary embodiment of the present disclosure.

FIG. 4A is a front view illustrating a gas spring unit using E-type retaining rings as securing rings, and FIG. 4B is a front view illustrating a gas spring unit using shaft collars as securing rings.

FIG. 5 is a diagram illustrating replacement of a gas spring unit.

FIGS. 6A, 6B, 6C, and 6D are respectively a top view, a left side view, a front view, and a right side view each illustrating a guide pocket.

FIGS. 7A and 7B are respectively a front view and a right side view each illustrating a gas spring unit provided with a positioning member.

### DESCRIPTION OF THE EMBODIMENTS

Gas in a gas spring may leak gradually as the gas spring is used repeatedly. This causes a decrease in reactive force generated by compression of the gas, and replacement of the gas spring becomes desirable. However, conventional gas springs are secured to covers or housings as described above. Further, in order to assist in opening and closing a heavy cover, a gas spring that is long in an extension and contraction direction and with a great reactive force is used, and this only allows another end portion of the gas spring to be secured at a back position in a housing at a distant from the cover. Thus, an operator needs to remove other units in the housing in order to replace the gas spring, which is inconvenient and bothersome.

Various exemplary embodiments, features, and aspects of the present disclosure make it possible to improve the ease of replacing a gas spring unit assisting in opening and closing a cover for operators, and will be described below with reference to the drawings.

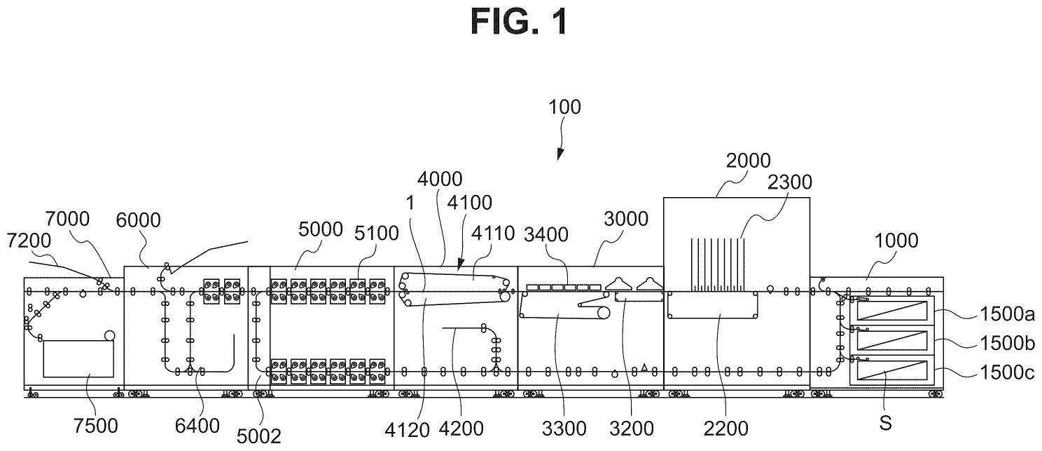

First, a suitable image forming apparatus using an opening and closing device according to an exemplary embodiment will be described below with reference to FIG. 1. A sheet-fed inkjet recording apparatus 100 configured to form images on sheets using ink and a reaction liquid will be described below as an example of an image forming apparatus. The sheets may be any recording materials capable of receiving the ink, and examples include paper such as plain paper or thick paper, plastic films such as sheets for overhead projectors, sheets with a special shape such as envelopes or index paper, and cloths.

In the present specification, the side on which an operator stands in operating the inkjet recording apparatus 100 will be referred to as “front side (or front)”, and the opposite side will be referred to as “rear side (or rear)”. Further, the left as viewed from the front will be referred to as “left”, and the right as viewed from the front will be referred to as “right”. FIG. 1 illustrates the inkjet recording apparatus 100 viewed from the front side.

### <Inkjet Recording Apparatus>

As illustrated in FIG. 1, the inkjet recording apparatus 100 includes a sheet feed module 1000, a print module 2000, a drying module 3000, a fixing module 4000, a cooling module 5000, a reversing module 6000, and a stacking module 7000. A sheet S fed from the sheet feed module 1000 undergoes various processes while being conveyed through the modules along a conveyance path and is eventually ejected to the stacking module 7000. The sheet S is an example of a medium for forming an image.

The sheet feed module 1000, the print module 2000, the drying module 3000, the fixing module 4000, the cooling module 5000, the reversing module 6000, and the stacking module 7000 may each include a separate housing, and the housings may be connected together to form the inkjet recording apparatus 100. Alternatively, the sheet feed module 1000, the print module 2000, the drying module 3000, the fixing module 4000, the cooling module 5000, the reversing module 6000, and the stacking module 7000 may be arranged in a single housing.

The sheet feed module 1000 includes storage cabinets 1500a, 1500b, and 1500c for storing the sheets S, and the storage cabinets 1500a to 1500c can be pulled out towards the front of the inkjet recording apparatus 100 to store the sheets S. The sheets S are singly fed from the storage cabinets 1500a to 1500c by a separation belt and a conveyance roller and conveyed to the print module 2000. The storage cabinets 1500a to 1500c are not limited to the three storage cabinets and may be one, two, four or more storage cabinets.

The print module 2000 includes a pre-image-forming registration correction portion (not illustrated), a print belt unit 2200, and a recording portion 2300. The sheet S conveyed from the sheet feed module 1000 undergoes skew and position correction performed by the pre-image-forming registration correction and is then conveyed to the print belt unit 2200. The recording portion 2300 is arranged opposite the print belt unit 2200 on the conveyance path. The recording portion 2300 as an image forming portion forms an image on the conveyed sheet S by performing a recording process (printing) on the sheet S from above using a recording head. The sheet S is conveyed by suction by the print belt unit 2200 to maintain clearance from the recording head. The recording head includes five line heads arranged along a conveyance direction and corresponding to a reaction liquid and four colors, such as yellow (Y), magenta (M), cyan (C), and black (Bk).

The number of ink colors and the number of heads of the recording head are not limited to five. An inkjet method such as a method using thermal elements, a method using piezoelectric elements, a method using electrostatic elements, or a method using micro electro mechanical systems (MEMS) elements may be adopted. Ink of each color is supplied from an ink tank (not illustrated) through an ink tube to the recording head. The sheet S printed by the recording portion 2300 is conveyed by the print belt unit 2200, and an inline scanner (not illustrated) positioned downstream of the recording portion 2300 in the conveyance direction detects misalignments in the image formed on the sheet S and color densities of the image to correct the printed image.

The drying module 3000 includes a decoupling portion 3200, a drying belt unit 3300, and a warm air blowing portion 3400. The drying module 3000 reduces the liquid content of the ink applied to the sheet S in order to increase the fixability of the ink to the sheet S by the subsequent fixing module 4000. The sheet S with the image formed thereon is conveyed to the decoupling portion 3200 arranged in the drying module 3000. At the decoupling portion 3200, the sheet S is conveyed by a belt by generating a frictional force between the sheet S and the belt by the pressure of air blowing from above. By conveying the sheet S on the belt using the frictional force as described above, misalignment of the sheet S that may occur during the conveyance through the print belt unit 2200 and the decoupling portion 3200 is prevented.

The sheet S conveyed from the decoupling portion 3200 is conveyed by suction by the drying belt unit 3300, and the warm air blowing portion 3400 positioned above the belt blows warm air against the sheet S to dry the ink applied to the sheet S. The drying module 3000 heats the ink applied to the sheet S and promotes evaporation of moisture to prevent cockling and prevent the ink from scattering that results in a border-like line nearby on the sheet S. While any apparatus capable of heating and drying may be used as the drying module 3000, the drying module 3000 is desirably, for example, a warm air drying machine or a heater. As to the heater, heating using an electric wire heater or an infrared heater is desirable from the standpoint of safety and energy efficiency.

The fixing module 4000 includes a fixing belt unit 4100. The fixing belt unit 4100 as a conveyance portion passes the sheet S conveyed from the drying module 3000 between a heated upper belt 4110 and a heated lower belt 4120 to fix the ink to the sheet S. The upper belt 4110 and the lower belt 4120 are brought into contact with each other to form a sheet conveyance path 1 for conveying the sheet S.

The cooling module 5000 includes a plurality of cooling portions 5100, and the cooling portions 5100 cool the high-temperature sheet S conveyed from the fixing module 4000. Each cooling portion 5100 cools the sheet S by, for example, bringing outside air into a cooling box to increase the pressure in the cooling box using fans and directing air blown out by the pressure from the cooling box through nozzles against the sheet S. The cooling portions 5100 are arranged on both sides of the conveyance path for the sheet S and cool both surfaces of the sheet S.

The cooling module 5000 is provided with a conveyance path switching portion 5002. The conveyance path switching portion 5002 switches the conveyance path for the sheet S based on whether the sheet S is to be conveyed to the reversing module 6000 or to a two-sided conveyance path for two-sided printing to form an image on both sides of the sheet S.

The reversing module 6000 includes a reversing portion 6400. The reversing portion 6400 reverses the front and back sides of the conveyed sheet S so that the sheet S is ejected to the stacking module 7000 with the front and back sides reversed. The stacking module 7000 includes a top tray 7200 and a stacking portion 7500 and stacks the sheet S conveyed from the reversing module 6000.

In two-sided printing, the sheet S is conveyed to a conveyance path at a lower portion of the cooling module 5000 by the conveyance path switching portion 5002. Thereafter, the sheet S is conveyed through a two-sided conveyance path of the fixing module 4000, the drying module 3000, the print module 2000, and the sheet feed module 1000 and returned to the print module 2000. A two-sided conveyance portion of the fixing module 4000 is provided with a reversing portion 4200 for reversing the front and back of the sheet S. The sheet S returned to the print module 2000 without an image formed on the opposite surface undergoes image forming so that an image is formed with ink on the opposite surface, and then the sheet S is conveyed through the drying module 3000, the fixing module 4000, the cooling module 5000, and the reversing module 6000 and ejected to the stacking module 7000.

Meanwhile, there may be a case where, for example, a sheet jam occurs in the sheet conveyance path 1 formed by the upper belt 4110 and the lower belt 4120 of the fixing module 4000. In this case, the jam of the sheet S is detected by a control unit (not illustrated) based on a signal of a detection sensor (not illustrated) provided to the sheet conveyance path 1. In a case where the jam of the sheet S is detected, an operator needs to expose the sheet conveyance path 1 in order to remove the sheet S remaining in the sheet conveyance path 1.

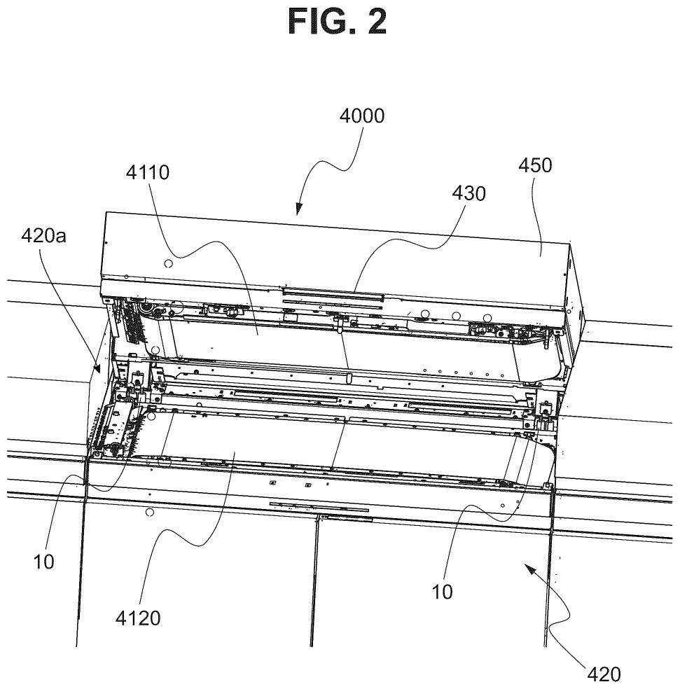

FIG. 2 is a perspective view illustrating a state where a top cover 450 of the fixing module 4000 is opened. The top cover 450 is pivotable around a pivot axis extending in a first direction. According to the present exemplary embodiment, the first direction is the same direction as the conveyance direction of the sheet S. In a state where the top cover 450 is closed, an opening portion 420a of a housing 420 is covered, whereas in a state where the top cover 450 is opened, the opening portion 420a of the housing 420 is exposed. Specifically, the top cover 450 opens and closes the opening portion 420a of a top surface of the housing 420.

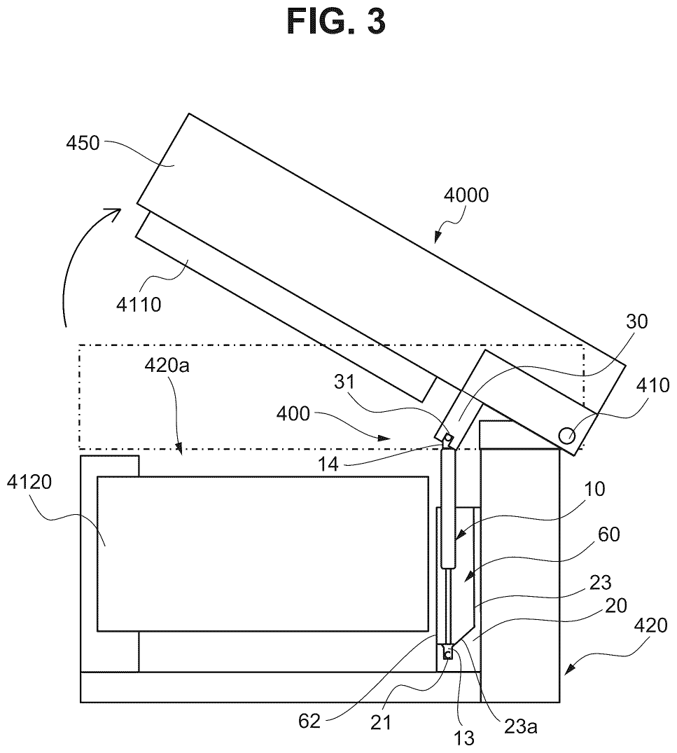

According to the present exemplary embodiment, as illustrated in FIG. 2, the operator moves the top cover 450 provided to the housing 420 of the fixing module 4000 upward to expose the sheet conveyance path 1 (refer to FIG. 1) from the opening portion 420a so that the operator can remove the sheet S from the sheet conveyance path 1. The top cover 450 is provided pivotably about a cover pivot shaft 410 (refer to FIG. 3) with respect to the housing 420 of the fixing module 4000. The cover pivot shaft 410 is provided on the rear side. The top cover 450 includes a handle 430 on the front side so that the operator can hold the handle 430 and move the top cover 450 upward easily.

The upper belt 4110 as a first conveyance belt is arranged in the top cover 450 and is moved integrally with the top cover 450. As the top cover 450 opens and closes, the upper belt 4110 is moved between a contact position where the upper belt 4110 is in contact with the lower belt 4120, which is a second conveyance belt, and forms the sheet conveyance path 1 with the lower belt 4120 and a separation position where the upper belt 4110 is separated from the lower belt 4120 and opens the sheet conveyance path 1. With the upper belt 4110 at the separation position, the sheet conveyance path 1 is exposed, and the operator can remove the sheet S remaining on the lower belt 4120. According to the present exemplary embodiment, the top cover 450 including the upper belt 4110 is pivotably supported on the rear side so that the front side of the top cover 450 can be opened upward.

### <Opening and Closing Apparatus>

The top cover 450 including the upper belt 4110 has a weight exceeding, for example, 700 N. Thus, according to the present exemplary embodiment, an opening and closing device 400 is provided to the fixing module 4000 to assist in opening and closing the top cover 450. The opening and closing device 400 will be described below with reference to FIGS. 3 to 7B. FIG. 3 is a right side view illustrating the opening and closing device 400.

As illustrated in FIG. 3, the top cover 450 is pivotably connected to the housing 420 of the fixing module 4000 by the cover pivot shaft 410 provided on the rear side. The opening and closing device 400 includes gas spring units 10 for assisting the operator in opening and closing the top cover 450. The gas spring units 10 are arranged at both ends of the top cover 450 in a left-right direction (refer to FIG. 2), and in a front-rear direction, the gas spring units 10 are positioned closer to the cover pivot shaft 410 of the top cover 450 than the lower belt 4120 in the housing 420 (in the housing). One end portion of each gas spring unit 10 is pivotably connected to a cover-side fitting member 30 provided to the top cover 450. Another end portion of each gas spring unit 10 is pivotably connected to a housing-side fitting member 20 provided in the housing 420. For convenience, each end portion connected to the top cover 450 will be referred to as “cover-side end portion”, and each end portion connected to the housing-side fitting member 20 will be referred to as “housing-side end portion”. According to the present exemplary embodiment, the gas spring units 10 extend and contract in a direction intersecting a pivot axis direction of the top cover 450.

### <Gas Spring Unit>

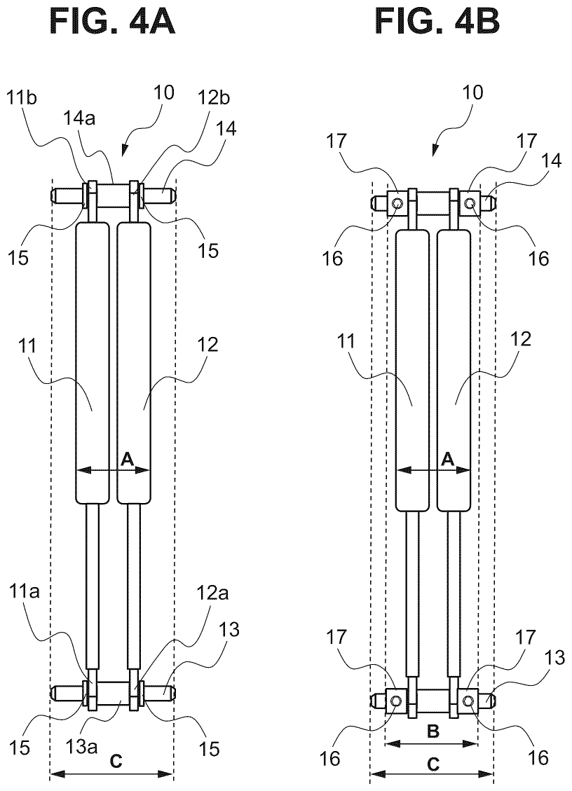

The gas spring units 10 for image forming apparatuses according to the present exemplary embodiment will be described below with reference to FIG. 4A. As illustrated in FIG. 4A, each gas spring unit 10 includes a first gas spring 11 and a second gas spring 12. The gas springs 11 and 12 are aligned in a direction (left-right direction according to the present exemplary embodiment) intersecting an extension and contraction direction of the gas springs 11 and 12 so that the gas springs 11 and 12 extend and contract in the same direction. A through hole is formed at each end of each of the gas springs 11 and 12. The arrangement of the gas springs 11 and 12 is not limited to the arrangement in which the gas springs 11 and 12 are aligned in the left-right direction, and the gas springs 11 and 12 may be aligned in the front-rear direction.

The gas springs 11 and 12 include rods and tubes, and rod-side end portions 11a and 12a (housing-side end portions) placed in the housing 420 are secured to a fitting support member 13 including a shaft portion extending in the pivot axis direction of the top cover 450. The fitting support member 13 is inserted into the through hole formed at the other end of the gas spring 11 and the through hole formed at the other end of the gas spring 12. Further, tube-side end portions 11b and 12b (cover-side end portions) placed on the top cover 450 are secured to a fitting support member 14 including a shaft portion extending in the pivot shaft direction of the top cover 450. The fitting support member 14 is inserted into the through hole formed at the one end of the gas spring 11 and the through hole formed at the one end of the gas spring 12. The housing-side end portions and the cover-side end portions are defined based on the orientation in which the gas springs 11 and 12 are placed. For example, in a case where the tube-side end portions 11b and 12b are placed in the housing 420, the tube-side end portions 11b and 12b are defined as housing-side end portions.

The fitting support member 13 is a housing-side shaft, and the fitting support member 14 is a cover-side shaft. The shaft portion of the fitting support member 13 (first shaft) is provided with a step portion 13a (intermediate portion) greater in diameter than the shaft portion of the fitting support member 13, and the shaft portion of the fitting support member 14 (second shaft) is provided with a step portion 14a (intermediate portion) greater in diameter than the shaft portion of the fitting support member 14. The step portions 13a and 14a are configured so that the rod-side end portions 11a and 12a and the tube-side end portions 11b and 12b of the gas springs 11 and 12 are arranged on the shaft portions with a predetermined space between the rod-side end portions 11a and 12a and a predetermined space between the tube-side end portions 11b and 12b to prevent the gas springs 11 and 12 from coming into contact with each other. Fixing rings 15 secure the rod-side end portions 11a and 12a and the tube-side end portions 11b and 12b of the gas springs 11 and 12 to prevent the rod-side end portions 11a and 12a and the tube-side end portions 11b and 12b from moving in the left-right direction on the shaft portions of the fitting support members 13 and 14. For example, E-type retaining rings are used as the securing rings 15. The fitting support members 13 and 14 have a length C longer than an outer tube width A of the gas springs 11 and 12 arranged in parallel (A<C in FIG. 4A). According to the present exemplary embodiment, the rod-side end portions 11a and 12a, the step portion 13a, the fitting support member 13, and the securing rings 15 are components of the housing-side end portion of the gas spring unit 10. Further, the tube-side end portions 11b and 12b, the step portion 14a, the fitting support member 14, and the securing rings 15 are components of the cover-side end portion of the gas spring unit 10.

The securing rings 15 are not limited to the E-type retaining rings illustrated in FIG. 4A. For example, as illustrated in FIG. 4B, shaft collars 17 may be used as the securing rings 15 and secured to the fitting support members 13 and 14 with set screws 16. In this case, the outer tube width A of the gas springs 11 and 12 arranged in parallel, an outer distance B between the shaft collars 17, and the length C of the fitting support members 13 and 14 have the relationship “A<B<C”.

### <Connection of Gas Spring Units>

Next, connection of the gas spring units 10 to the cover-side fitting members 30 and the housing-side fitting members 20 will be described below. The cover-side fitting members 30 are provided at both end portions in the left-right direction in the top cover 450 as illustrated in FIG. 3. Each cover-side fitting member 30 includes a projection portion extending downward from a lower end portion of the top cover 450, and a U-shaped groove 31 is formed at the tip of the projection portion. The shaft portion of the fitting support member 14 to which the tube-side end portions 11b and 12b of the gas springs 11 and 12 are secured is fitted to the U-shaped groove 31 to connect the gas spring unit 10 to the cover-side fitting member 30 so that the gas spring unit 10 is pivotable about a shaft substantially parallel to the cover pivot shaft 410 and is easily attachable and detachable.

Meanwhile, the housing-side fitting members 20 are provided at both end portions in the left-right direction in the housing 420. A U-shaped groove 21 as a recess portion is formed at a bottom portion of each housing-side fitting member 20. The shaft portion of the fitting support member 13 to which the rod-side end portions 11a and 12a of the gas springs 11 and 12 are secured is fitted to the U-shaped groove 21 to connect the gas spring unit 10 to the housing-side fitting member 20 so that the gas spring unit 10 is pivotable about a shaft substantially parallel to the cover pivot shaft 410 and is easily attachable and detachable.

Gas is sealed in the tubes of the gas springs 11 and 12, and a reactive force corresponding to extension and contraction states of the rods with respect to the tubes is generated by the gas in the gas springs 11 and 12. In the case of the gas spring unit 10 according to the present exemplary embodiment, the rods enter the tubes of the gas springs 11 and 12 as the top cover 450 is closed, and the rods compress the gas in the tubes. Then, as the top cover 450 is opened, a reactive force is generated by the gas compressed in the gas springs 11 and 12 to assist the opening operation of the top cover 450, so that the operator can open the top cover 450 smoothly.

Meanwhile, the gas springs 11 and 12 may degrade over time during their lifespans, and regular replacement or replacement due to accidental failure becomes desirable. In the commercial printing market, an availability rate of the inkjet recording apparatus 100 is one of the metrics important to the operator, so that the operator is expected to complete the replacement operations of the gas spring units 10 quickly and reliably. Thus, the connection configuration according to the present exemplary embodiment is employed in which the shaft portion of the fitting support member 14 is fitted to the U-shaped groove 31 of the cover-side fitting member 30 and the shaft portion of the fitting support member 13 is fitted to the U-shaped groove 21 of the housing-side fitting member 20 so that the shaft portions are easily attachable and detachable as described above.

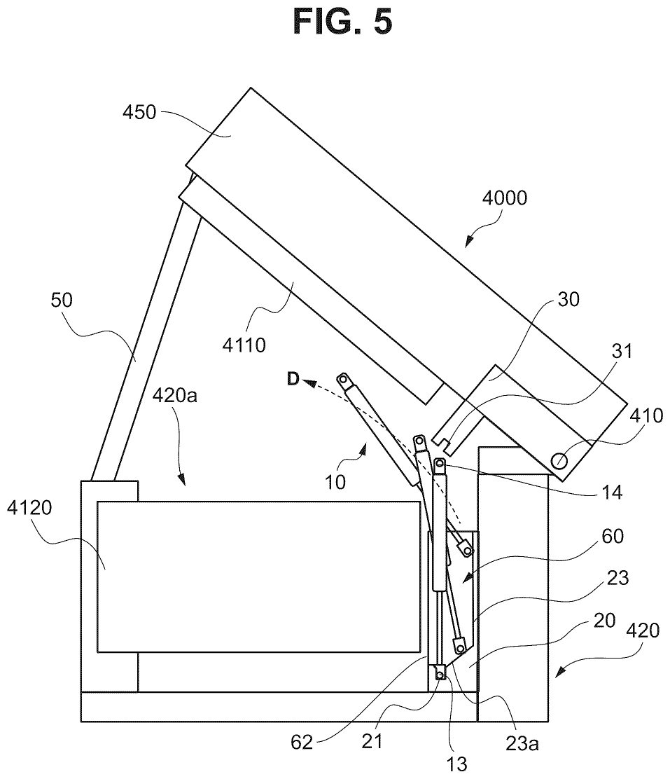

The replacement operations of the gas spring units 10 will be described below. To perform the replacement operations of the gas spring units 10, the operator moves the handle 430 formed on the front side of the top cover 450 upward and pivots the top cover 450 upward as illustrated in FIG. 5. As described above, according to the present exemplary embodiment, the drying module 3000 is positioned upstream of the fixing module 4000 and the cooling module 5000 is positioned downstream of the fixing module 4000 in the conveyance direction of the sheet S, so that it is difficult to access the gas spring units 10 from the right or left side and replace the gas spring units 10. Thus, according to the present exemplary embodiment, a cover support member 50 supports the top cover 450 in a state where the front of the top cover 450 is moved upward and opened so that the operator can access the inside of the housing 420 from the front to replace the gas spring units 10.

In removing each gas spring unit 10, the top cover 450 is opened to a maintenance position and supported at the maintenance position by the cover support member 50. At the maintenance position, the top cover 450 is opened wider than during jam clearing operations. In this case, the gas springs 11 and 12 of the gas spring unit 10 are in their free length state, and the shaft portion of the fitting support member 14 is released from the U-shaped groove 31 of the cover-side fitting member 30. In other words, the fitting of the shaft portion of the fitting support member 14 in the U-shaped groove 31 of the cover-side fitting member 30 is released in a case where the top cover 450 is pivoted beyond a predetermined pivot amount (a threshold amount) in a state where the gas spring unit 10 is attached to the top cover 450. The cover support member 50 supports the top cover 450 in a state where the top cover 450 is pivoted beyond the predetermined pivot amount.

Thus, the operator can hold the gas spring unit 10 positioned further back than the lower belt 4120 from the opening portion 420a and move the held gas spring unit 10 diagonally forward (arrow D direction in FIG. 5) while avoiding the lower belt 4120. As the gas spring unit 10 is moved diagonally forward, the shaft portion of the fitting support member 13 is released from the U-shaped groove 21 of the housing-side fitting member 20, so that the operator can remove the gas spring unit 10 from the housing 420.

The cover support member 50 may be provided in advance to the housing 420, or instead of providing the cover support member 50 to the housing 420, the cover support member 50 that is prepared separately may be attached externally.

In attaching each gas spring unit 10, on the other hand, in a state where the top cover 450 is supported by the cover support member 50, the gas spring unit 10 is inserted in the opposite direction to the arrow D direction into the housing 420 with the fitting support member 13 side first from the opening portion 420a. The housing-side fitting member 20 is provided with a guide pocket 60 as a guide portion for guiding the gas spring unit 10. The guide pocket 60 is provided to restrict the movement range of the gas spring unit 10 by bringing the fitting support member 13 into contact with the guide pocket 60 and guide the gas spring unit 10 to the position where the shaft portion of the fitting support member 13 fits into the U-shaped groove 21 of the housing-side fitting member 20.

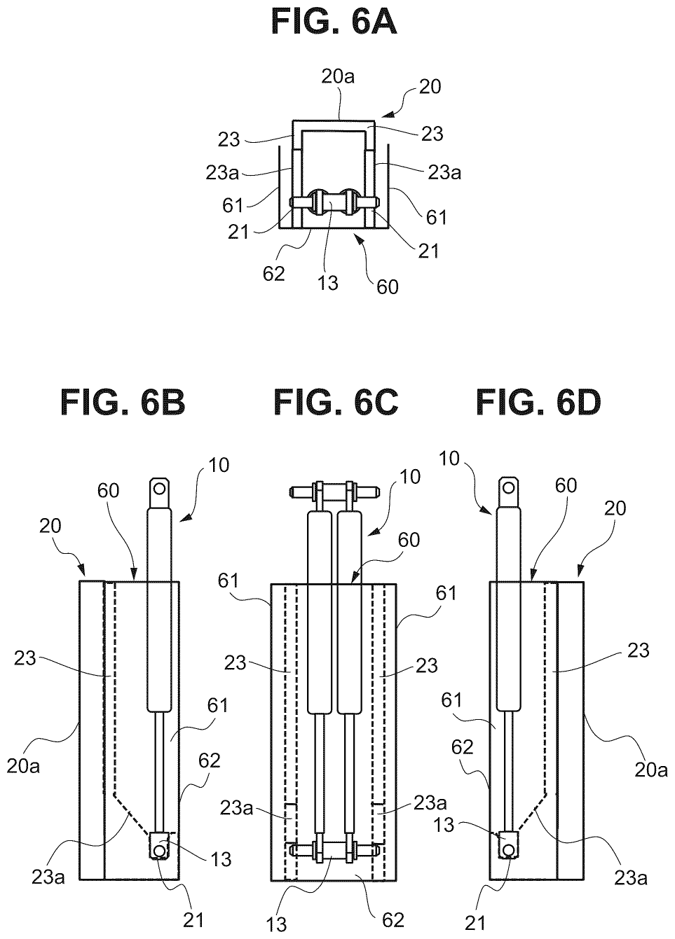

The guide pocket 60 will be described below. As illustrated in FIGS. 6A to 6D, the guide pocket 60 includes side guides 61 and a front guide 62 positioned on the front side and spanned between the side guides 61. The side guides 61 are provided at both end portions of the guide pocket 60 in the left-right direction and extend in an up-down direction. Further, the housing-side fitting member 20 includes rear guide portions 23 provided at both end portions of the housing-side fitting member 20 in the left-right direction and extending in the up-down direction. The side guides 61, the front guide 62, and the rear guide portions 23 of the housing-side fitting member 20 form an insertion and removal opening portion 60a for inserting and removing the gas spring unit 10. In a case where the gas spring unit 10 is inserted into the inside from the insertion and removal opening portion 60a, the fitting support member 13 moves within the space surrounded by the side guides 61, the front guide 62, and the rear guide portions 23 of the housing-side fitting member 20. In this case, the fitting support member 13 is sandwiched between the two side guides 61 in the left-right direction (pivot shaft direction). Thus, by bringing end surfaces of the shaft portion of the fitting support member 13 into contact with the side guides 61, serving as a first regulation portion, the range of the gas spring unit 10 in the left-right direction (pivot axis direction) is restricted. The side guides 61 include flat plate portions positioned opposed to each other to sandwich the fitting support member 13 in the left-right direction, and the flat plate portions are brought into contact with the end surfaces of the fitting support member 13 to restrict the movement range of the gas spring unit 10 in the left-right direction.

Further, the rear guide portions 23 as a second regulation portion extend from the insertion and removal opening portion 60a to the U-shaped groove 21 of the housing-side fitting member 20. While the fitting support member 13 moves within the space surrounded by the side guides 61, the front guide 62, and the rear guide portions 23 of the housing-side fitting member 20, side surfaces of the shaft portion of the fitting support member 13 are brought into contact with the rear guide portions 23 to restrict the movement range of the gas spring unit 10 in the insertion direction. Each lower end portion 23a of the rear guide portions 23 is formed with an inclined shape from a rear surface 20a of the housing-side fitting member 20 to the U-shaped groove 21 of the housing-side fitting member 20. After the side surfaces of the shaft portion of the fitting support member 13 are brought into contact with the lower end portions 23a, the shaft portion of the fitting support member 13 slides in a state where the shaft portion is in contact with the lower end portions 23a. Specifically, the fitting support member 13 is guided to a fitting position by the lower end portions 23a. Thus, by inserting the gas spring unit 10 while pressing the shaft portion of the fitting support member 13 against the rear guide portions 23 from the front side, the operator can reliably fit the shaft portion of the fitting support member 13 into the U-shaped groove 21 of the housing-side fitting member 20. Thus, the operator can easily attach the gas spring unit 10.

As described above, according to the present exemplary embodiment, the fitting support member 14 (cover-side shaft) of the cover-side end portion of the gas spring unit 10 is pivotably fitted to the cover-side fitting member 30 of the top cover 450. The fitting support member 13 (housing-side shaft) of the housing-side end portion of the gas spring unit 10 is pivotably fitted to the housing-side fitting member 20 of the housing 420. The housing-side fitting member 20 is provided with the guide pocket 60 for guiding the gas spring unit 10. The guide pocket 60 restricts the movement range of the gas spring unit 10 in the left-right direction by bringing the side guides 61 and the end surfaces of the shaft portion of the fitting support member 13 into contact with each other. Further, the movement of the gas spring unit 10 in the insertion direction is restricted by bringing the rear guide portions 23 and the side surfaces of the shaft portion of the fitting support member 13 into contact with each other. The gas spring unit 10 is guided to the U-shaped groove 21 of the housing-side fitting member 20 by the lower end portions 23a of the rear guide portions 23. As described above, the operator can reliably fit the shaft portion of the fitting support member 13 into the U-shaped groove 21 of the housing-side fitting member 20 by simply inserting the gas spring unit 10 as guided by the guide pocket 60 in attaching the gas spring unit 10. This makes it possible to improve the ease of gas spring replacement operations for the operator.

For smooth opening and closing of the top cover 450 having a weight exceeding 700 N, a gas spring with a large extension force needs to be used. In the case of a standard gas spring, the greater the maximum length of the gas spring, the greater the extension force of the gas spring. Thus, in order to assist in opening and closing the top cover 450 having a weight exceeding 700 N, a gas spring with a large maximum length needs to be used. In order to do so, however, a large space is needed inside the housing 420 to allow the gas spring to extend and contract in the space, which may lead to an increase in size of the housing 420. Further, in a case where two gas springs with a large extension force are used, a failure of one of the gas springs for some reason decreases the assistance force of the gas springs by half, which not only makes it difficult to open and close the top cover 450 smoothly but also may lead to a decrease in safety in the replacement operations.

On the contrary, according to the present exemplary embodiment, the gas spring units 10 each including the two gas springs 11 and 12 connected together are placed at the right and left positions between the top cover 450 and the housing 420.

This makes it possible to reduce the size of the housing 420 and the gas spring operating space. Further, since a plurality of gas springs (four or more gas springs) is used, a decrease in the extension force of the individual springs having different aging characteristics from each other does not lead to a sudden change in the assistance force, so that safety of the replacement operations is enhanced. The present exemplary embodiment is advantageous because even in a case where the gas spring units 10 described above are employed, it is still easy to replace the gas spring units 10.

### Other Exemplary Embodiments

Meanwhile, as the gas springs 11 and 12 of the gas spring unit 10 are used repeatedly, the gas in the tubes of the gas springs 11 and 12 may leak gradually, and the extension force of the gas springs 11 and 12 may decrease.

The gas in the tube of the gas spring 11 and the gas in the tube of the gas spring 12 leak differently from each other.

Thus, desirably, the gas springs 11 and 12 are configured to allow for separate removal and replacement from the gas spring unit 10. Specifically, it is desirable to provide the gas springs 11 and 12 so that the gas springs 11 and 12 are not secured to the fitting support members 13 and 14 and are easily attachable to and detachable from the fitting support members 13 and 14.

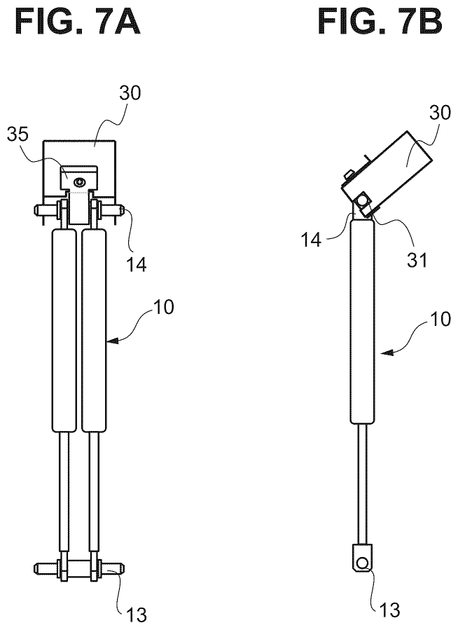

However, in a case where the gas springs 11 and 12 are not secured to the fitting support members 13 and 14, the gas springs 11 and 12 may both move in the left-right direction along the fitting support members 13 and 14 and come into contact with each other, which may cause damage. Thus, according to the present exemplary embodiment, as illustrated in FIGS. 7A and 7B, the cover-side fitting member 30 is provided with a positioning member 35 for positioning the gas springs 11 and 12 at predetermined positions of the fitting support member 14 with a space between the predetermined positions in the left-right direction. After the fitting support member 14 of the gas spring unit 10 is fitted to the U-shaped groove 31 of the cover-side fitting member 30 and supported, the positioning member 35 is attached to the cover-side fitting member 30 so that the positioning member 35 enters between the end portions 11b and 12b of the gas springs 11 and 12, and the gas springs 11 and 12 are sandwiched between the securing rings 15 and the positioning member 35, whereby the positions of the gas springs 11 and 12 in the left-right direction are determined.

In the above-described exemplary embodiment, while a case where the gas spring unit 10 is replaced is described as an example, this should not be considered a limitation, as the present disclosure is also applicable to a case where a gas spring is used individually.

Further, in the above-described exemplary embodiment, while an application to the fixing module 4000 is described as an example, this should not be considered a limitation. There may be a case where the sheet feed module 1000, the drying module 3000, the cooling module 5000, the reversing module 6000, and the stacking module 7000 also include a top cover, like the fixing module 4000 and, for example, a part of a conveyance portion may be provided to the top cover. The present disclosure is also applicable to the sheet feed module 1000, the drying module 3000, the cooling module 5000, the reversing module 6000, and the stacking module 7000 in the foregoing case.

The present disclosure makes it possible to improve the ease of replacing a gas spring unit that assists opening and closing of a cover provided on a housing for operators.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-172271, filed Oct. 3, 2023, which is hereby incorporated by reference herein in its entirety.

What is claimed is:

1. An opening and closing device comprising:
a housing having a top surface including an opening portion;
a cover provided to the housing to be pivotable about a pivot axis extending in a first direction, and configured to open and close the opening portion by pivoting about the pivot axis; and
a gas spring unit configured to extend and contract with the pivoting of the cover and including a cover-side end portion fitted to the cover and a housing-side end portion fitted to the housing,
wherein the cover-side end portion of the gas spring unit includes a cover-side shaft extending in the first direction,
wherein the cover includes a cover-side fitting portion to which the cover-side shaft is fitted,
wherein the gas spring unit supports the cover in a state where the gas spring unit is pivotable about the cover-side shaft with respect to the cover, by the cover-side shaft fitting to the cover-side fitting portion,
wherein the housing-side end portion of the gas spring unit includes a housing-side shaft extending in the first direction,
wherein the housing includes a housing-side fitting portion to which the housing-side shaft is fitted,
wherein the housing supports the gas spring unit in a state where the gas spring unit is pivotable about the housing-side shaft with respect to the housing, by the housing-side shaft fitting to the housing-side fitting portion, and
wherein the housing further includes a guide portion configured to restrict a movement range of the gas spring unit by coming into contact with the housing-side shaft in inserting of the housing-side end portion into the housing from the opening portion and to guide the housing-side shaft to a position where the housing-side shaft fits to the housing-side fitting portion.

2. The opening and closing device according to claim 1, wherein the housing-side fitting portion includes a recess portion configured to receive a side surface of the housing-side shaft so that the housing-side shaft fits to the recess portion.

3. The opening and closing device according to claim 1,
wherein the guide portion includes a first regulation portion,
wherein the first regulation portion includes two plate portions positioned opposed to each other to sandwich the housing-side shaft in the first direction, and
wherein the first regulation portion is configured to restrict a movement range of the gas spring unit in the first direction by having the two plate portions respectively contact with end surfaces of the housing-side shaft in the inserting of the housing-side end portion into the housing from the opening portion,

4. The opening and closing device according to claim 3,
wherein the guide portion includes a second regulation portion,
wherein the second regulation portion is configured to restrict a movement range of the gas spring unit in an insertion direction by contacting with a side surface of the housing-side shaft in the inserting of the housing-side end portion into the housing from the opening portion, and
wherein the housing-side shaft is guided by the housing-side shaft sliding in a state where the side surface of the housing-side shaft is in contact with the second regulation portion.

5. The opening and closing device according to claim 1,
wherein, in a case where the cover is pivoted from a closed state of the cover by a first pivot amount below a threshold amount, the cover is supported by the gas spring unit fitted to the cover, and
wherein, in a case where the cover is pivoted from the closed state of the cover by a second pivot amount beyond the threshold amount, the fitting of the cover-side shaft in the cover-side fitting portion is released.

6. The opening and closing device according to claim 5, further comprising a cover support member configured to support the cover in a state where the cover is pivoted from the closed state of the cover beyond the threshold amount.

7. The opening and closing device according to claim 5, further comprising a cover support member configured to support the cover when the fitting of the cover-side shaft in the cover-side fitting portion is released.

8. The opening and closing device according to claim 5, wherein the cover-side fitting portion includes a recess portion to which the cover-side shaft is fitted.

9. The opening and closing device according to claim 1,
wherein the gas spring unit includes a first gas spring and a second gas spring, each configured to extend and contract,
wherein the first gas spring includes a first through hole at end of the first gas spring on the cover-side end portion and a second through hole at end of the first gas spring on the housing-side end portion,
wherein the second gas spring includes a third through hole at end of the second gas spring on the cover-side end portion and a fourth through hole at end of the second gas spring on the housing-side end portion,
wherein the cover-side shaft is inserted into both the first through hole of the first gas spring and the third through hole of the second gas spring, and
wherein the housing-side shaft is inserted into both the second through hole of the first gas spring and the fourth through hole of the second gas spring.

10. The opening and closing device according to claim 9,
wherein the cover-side shaft includes an inserted portion and an intermediate portion,
wherein the inserted portion is inserted inside the first or third through hole,
wherein the intermediate portion is positioned between the first gas spring and the second gas spring, and
wherein the intermediate portion has a diameter larger than a diameter of the inserted portion.

11. The opening and closing device according to claim 9,
wherein the housing-side shaft includes an inserted portion and an intermediate portion,
wherein the inserted portion is inserted inside the second or fourth through hole,
wherein the intermediate portion is positioned between the first gas spring and the second gas spring, and
wherein the intermediate portion has a diameter larger than a diameter of the inserted portion.

12. The opening and closing device according to claim 1, wherein the gas spring unit is fitted to the housing in a manner that the gas spring unit is attachable to and detachable from the housing.

13. An image forming apparatus comprising:
the opening and closing device according to claim 1; and
an image forming portion configured to form an image on a medium.

14. An image forming apparatus comprising:
the opening and closing device according to claim 1; and
a conveyance device configured to convey a medium for forming an image,
wherein the conveyance device includes a first conveyance belt provided in the cover and a second conveyance belt provided in the housing.

15. A gas spring unit for an image forming apparatus, the gas spring unit comprising:
a first gas spring configured to extend and contract in a first direction;
a second gas spring configured to extend and contract in the first direction;
a first shaft extending in a second direction intersecting the first direction; and
a second shaft extending in the second direction,
wherein the first gas spring includes a first through hole at end of the first gas spring on a first side in the first direction and a second through hole at end of the first gas spring on a second side in the first direction,
wherein the second gas spring includes a third through hole at end of the second gas spring on the first side and a fourth through hole at end of the second gas spring on the second side,
wherein the first shaft is inserted into both the first through hole of the first gas spring and the third through hole of the second gas spring, and
wherein the second shaft is inserted into both the second through hole of the first gas spring and the fourth through hole of the second gas spring.

16. The gas spring unit according to claim 15,
wherein each of the first shaft and the second shaft includes an inserted portion and an intermediate portion,
wherein the inserted portion is inserted inside one of the first through fourth through hole,
wherein the intermediate portion is positioned between the first gas spring and the second gas spring, and
wherein the intermediate portion has a diameter larger than a diameter of the inserted portion.
